(19) United States
(12) Patent Application Publication
(10) Pub. No.: US 2006/0133503 A1
(43) Pub. Date: Jun. 22, 2006

(54) Method for scalably encoding and decoding video signal

(76) Inventors: Seung Wook Park, Sungnam-si (KR); Ji Ho Park, Sungnam-si (KR); Byeong Moon Jeon, Sungnam-si (KR)

Correspondence Address: HARNESS, DICKEY & PIERCE, P.L.C., P.O. BOX 8910, RESTON, VA, 20195, US

(21) Appl. No.: 11/293,132

(22) Filed: Dec. 5, 2005

Related U.S. Application Data
(60) Provisional application No. 60/632,974, filed on Dec. 6, 2004.

(30) Foreign Application Priority Data
Jul. 4, 2005 (KR) 10-2005-0059778

(51) Int. Cl. H04N 11/02; H04N 7/12; H04N 11/04; H04B 1/66

(52) U.S. Cl. 375/240.16; 375/240.08; 375/240.24

(57) ABSTRACT

Disclosed is a method for scalably encoding and decoding a video signal. The video signal is encoded through an inter-layer prediction scheme based on a data stream of a base layer encoded with ×¼ resolution. The inter-layer prediction scheme applied between the enhanced layer and the base layer representing ×4 resolution difference includes a motion prediction scheme for predicting motion and dividing a macro block of the enhanced layer based on division information, mode information, and/or mode information of a block of the base layer. Thus, the inter-layer prediction scheme is applied between layers representing ×4 resolution difference, thereby improving a coding efficiency.

### PRIORITY INFORMATION

This application claims priority under 35 U.S.C. §119 on Korean Patent Application No. 10-2005-0059778, filed on Jul. 4, 2005, the entire contents of which are hereby incorporated by reference.

This application also claims priority under 35 U.S.C. §119 on U.S. Provisional Application No. 60/632,974, filed on Dec. 6, 2004; the entire contents of which are hereby incorporated by reference.

### BACKGROUND OF THE INVENTION

1. Field of the Invention

The present invention relates to a method for scalably encoding and decoding a video signal, and more particularly to a method for encoding a video signal by employing an inter-layer prediction scheme on the basis of a base layer having ×¼ resolution and decoding the encoded video data.

2. Description of the Prior Art

It is difficult to allocate a broadband available for TV signals to wirelessly transmitted/received digital video signals wirelessly transmitted/received from/in a portable phone and a notebook computer, which have been extensively used, and a mobile TV and a hand held PC, which are expected to be extensively used in the future. Accordingly, a standard to be used for a video compression scheme for such portable devices must enable a video signal to be compressed with a relatively high efficiency.

In addition, such portable mobile devices are equipped with various processing and presentation capabilities. Accordingly, compressed videos must be variously prepared corresponding to the capabilities of the portable devices. Therefore, the portable devices must be equipped with video data having various qualities obtained through the combination of various parameters including the number of transmission frames per second, resolution, and the number of bits per pixel with respect to one video source, burdening content providers.

For this reason, the content provider prepares compressed video data having a high bit rate with respect to one video source so as to provide the portable devices with the video data by decoding the compressed video and then encoding the decoded video into video data suitable for a video processing capability of the portable devices requesting the video data. However, since the above-described procedure necessarily requires transcoding (decoding+scaling+encoding), the procedure causes a time delay when providing the video requested by the portable devices. In addition, the transcoding requires complex hardware devices and algorithms due to the variety of a target encoding.

In order to overcome these disadvantages, there is suggested a Scalable Video Codec (SVC) scheme. According to the SVC scheme, a video signal is encoded with a best video quality in such a manner that the video quality can be ensured even though parts of the overall picture sequences (frame sequences intermittently selected from among the overall picture sequences) derived from the encoding are decoded.

A motion compensated temporal filter (or filtering) (MCIT) is an encoding scheme suggested for the SVC scheme. The MCTF scheme requires high compression efficiency, that is, high coding efficiency in order to lower the number of transmitted bits per second because the MCTF scheme is mainly employed under a transmission environment such as mobile communication having a restricted bandwidth.

As described above, although it is possible to ensure video quality even if only a part of the sequence of a picture encoded through the MCTF, which is a kind of the SVC scheme, is received and processed, video quality may be remarkably degraded if a bit rate is lowered. In order to overcome the problem, an additional assistant picture sequence having a low transmission rate, for example, a small-sized video and/or a picture sequence having the smaller number of frames per second may be provided.

The assistant picture sequence is called a base layer, and a main picture sequence is called an enhanced (or enhancement) layer. The enhanced layer has a relative relationship with the base layer. When two layers are selected from among a plurality of layers, a layer having relatively lower resolution and a relatively lower frame rate becomes a base layer, and a remaining layer becomes an enhanced layer. For example, on an assumption that there are three layers having image resolution of 4 CIF (4 times common intermediate format), CIF, and QCIF (quarter CIF), the layer having the resolution of the QCIF may be a base layer, and remaining two layers may be enhanced layers.

When comparing image resolutions or image sizes with each other, the 4 CIF is four times the CIF or 16 times the QCIF based on the number of overall pixels or an area occupied by overall pixels when the pixels are arranged with the same interval in right and left directions. In addition, based on the number of pixels in a width direction and a length direction, the 4CIF becomes twice of the CIF and four times the QCIF. Hereinafter, the comparison of the image resolution or the image sizes is achieved based on the number of pixels in a width direction and a length direction instead of the area or the number of the overall pixels, so that the resolution of the CIF becomes ½ times the 4CIF and twice the QCIF.

FIG. 1 is block diagram illustrating the structure of a scalable codec employing scalability according to temporal, spatial, and SNR or quality aspects based on a ‘2D+t’ structure.

One video source is encoded by classifying several layers having different resolutions including a video signal (Layer 0) with an original resolution (an image size), a video signal (Layer 1) with half original resolution, and a video signal (Layer 2) with a quarter original resolution. In this case, the same encoding scheme or different encoding schemes may be employed for the several layers. The present invention employs an example in which the layers are individually encoded through the MCTF scheme.

Since each of the layers having different resolutions is encoded by employing different spatial resolutions and different frame rates for the same video contents, there is redundancy information in data streams obtained by encoding the layers. Accordingly, a video signal of a predetermined layer (e.g., an enhanced layer) is predicted using a data stream obtained by encoding a layer (e.g., a base layer) having lower resolution as compared with that of the predetermined layer in order to improve a coding efficiency of the predetermined layer. This prediction is called an “inter-layer prediction scheme”.

The inter-layer prediction scheme includes a texture prediction scheme, a residual prediction scheme, or a motion prediction scheme.

Hereinafter, detailed description about an example in which the inter-layer prediction such as the texture prediction scheme, the residual prediction scheme, or the motion prediction scheme is employed between layer 0 and layer 1 or the layer 1 and a layer 2 representing a resolution difference of ×2.

In the texture prediction scheme, if a block of the layer 1 corresponding to a macro block of the layer 0 is encoded in an intra mode (herein, among blocks positioned at a frame temporally simultaneous with the macro block of the layer 0, the corresponding block is a block having an area covering the macro block when the corresponding block is enlarged to twice of the size thereof according to the ratio of an image size of the layer 0 to an image size of the layer 1, a corresponding area as a part of the corresponding block, which has a relative position identical to that of the macro block in a frame, (the number of pixels of the corresponding area in a width direction and in a length direction is a half number of pixels of the macro block) is restored to an original image based on pixel values of another area for the intra mode, the restored area is enlarged to the size of the macro block by up-sampling the restored area to twice the size thereof corresponding to the ratio of the layer 0 resolution to the layer 1 resolution, and then the macro block in the layer 0 is encoded into a difference between pixel values of the enlarged corresponding area and the macro block. An “intra_BASE_flag” is set to a predetermined value such as ‘1’ and then recorded on a header field of the macro block so as to indicate that the macro block is encoded based on the corresponding area of the layer 1 having a half the layer 0 resolution encoded in the intra mode.

In the residual prediction scheme, a residual block (a block encoded to have residual data) for a macro block in a predetermined frame is found by performing a prediction operation for a video signal of the layer 0. In this case, a prediction operation has been performed for a video signal of the layer 1, and a residual block of the layer 1 has been already created. Thereafter, a residual block of the layer 1 corresponding to the macro block and encoded to have residual data is found, a corresponding residual area as a part of the corresponding residual block, which has a relative position identical to that of the macro block in a frame, (the corresponding residual area is encoded to have residual data and has the number of pixels corresponding to the number of pixels of a half the macro block in a width direction and in a length direction) is enlarged to the size of the macro block by upsampling it to twice the size thereof corresponding to the ratio of the layer 0 resolution to the layer 1 resolution and then encoded in the macro block of the layer 0 by subtracting pixel values of the enlarged corresponding residual area of the layer 1 from pixel values of the residual block of the layer 0. An “residual_prediction_flag” is set to a predetermined value such as ‘1’ and then recorded on the header field of the macro block so as to indicate that the macro block is encoded into difference values of residual data based on the corresponding residual area of the layer 1 having a half the layer 0 resolution.

The motion prediction scheme is classified into i) a scheme for employing division information and a motion vector obtained with respect to the layer 0, ii) a scheme for employing division information and a motion vector of the corresponding block of the layer 1, and iii) a scheme for employing the division information of the corresponding block of the layer 1 and a difference between the motion vector of the layer 0 and the motion vector of the layer 1.

First, a scheme for employing division information of a macro block of the layer 1 applied to cases of ii) and iii) will be described. Then, a criterion of selecting one of the three cases will be described. Finally, a scheme of employing a motion vector in each case will be described.

First, a scheme for creating a prediction image of the layer 0 using motion information and/or division information of the macro block of the layer 1 will be described.

A current macro block of the layer 0 is divided based on the division information about the corresponding block of the layer 1 corresponding to the current macro block and the ratio of a layer 0 image size (or resolution) and a layer 1 image size (or resolution). In addition, blocks of the layer 0, which are obtained through the division information of the corresponding block of the layer 1, are encoded based on motion information of the corresponding block of the layer 1 including a motion vector and data (a reference index) indicating a frame having a reference block.

Since the ratio of the layer 0 image size to the layer 1 image size is equal to 2, four 16×16-sized macro blocks of the layer 0 may be encoded based on division information and motion information of a 16×16-sized corresponding block of the layer 1.

As shown in FIG. 2, if the corresponding block of the layer 1 is divided into 4×4-sized blocks, 4×8-sized blocks, or 8×4-sized blocks and encoded, the current macro block of the layer 0 is divided into 8×8-sized blocks, 8×16-sized blocks, or 16×8-sized blocks corresponding to twice the 4×4-sized blocks, twice the 4×8-sized blocks, or twice the 8×4-sized blocks, respectively. In addition, if the corresponding block of the layer 1 is divided into the 8×8-sized blocks, the 8×8-sized block becomes one macro block of the layer 0 because the size of 16×16 corresponding to twice the size of 8×8 is the size of 16×16 which is the maximum size of a macro block.

In addition, in a case in which the corresponding block of the layer 1 has been divided into 8×16-sized blocks, 16×8-sized blocks, or 16×16-sized blocks and encoded, since the sizes corresponding to twice the sizes of the blocks are larger than 16×16, which is the maximum size of a macro block, the current macro block cannot be divided, and neighboring two or four macro blocks including the current macro block have the same corresponding block. Accordingly, the 8×16, 16×8, or 16×16-sized block corresponds to two or four macro blocks of the layer 0.

If a macro block of the layer 1 has been encoded in a direct mode (In this direct mode, the macro block of the layer 1 is encoded using a motion vector for a block having the same position in another frame as it is or encoded using its motion vector found based on a motion vector for neighboring another macro block, and its motion vector is not recorded), a macro block of the layer 0 corresponding to the macro block of the layer 1 is encoded into a 16×16-sized block.

In addition, if a 16×16-sized block of the layer 1 corresponding to the current macro block has been encoded in an intra mode, neighboring four macro blocks including the current macro block are encoded in an intra base mode (intra_BASE_mode) employing the corresponding block of the layer 1 as a reference block.

A “base_layer_mode_flag” set to a value such as ‘1’ is recorded on the header field of the macro block so as to indicate that the macro block of the layer 0 is divided through division information about the corresponding block of the layer 1 and encoded using motion information about the corresponding block of the layer 1.

Hereinafter, a scheme for encoding a motion vector of a picture of the layer 0 temporally simultaneous with a picture of the layer 1 using a motion vector of the picture of the layer 1 will be described.

A motion vector (mv) to a reference block is found through a motion prediction operation for a predetermined macro block in a frame of the layer 0, and a motion vector (mvScaledBL) is obtained by ×2 scaling a motion vector (mvBL) of a macro block covering an area in a frame of the layer 1 corresponding to the macro block of the layer 0 corresponding to the resolution difference between the layer 0 and the layer 1.

With respect to each of the two vectors (mv and mvScaledBL) and a difference between the two vectors (mv and mvScaledBL), three cases according to costs calculated based on a residual error which is a difference between images generated by the two vectors (mv and mvScaledBL) and a real image and the number of total bits to be used in encoding are as follows. I) encoding is performed in such a manner that the motion vector found in the layer 0 can be used as it is if the cost of the motion vector (mv) found in the layer 0 is smaller than a cost corresponding to remaining two cases. Hereinafter, when an inter-layer prediction scheme is mentioned, this case will be excluded.

II) If the motion vector (mvScaledBL) obtained by scaling the motion vector of the corresponding block of the layer 1 has a smaller cost as compared with those of remaining cases, information indicating that the motion vector for the macro block of the layer 0 is identical to the motion vector obtained by scaling the motion vector of the corresponding block of the layer 1 is recorded on the header of the corresponding macro block. In other words, without provision of addition motion vector information, a flag (base_layer_mode_flag) representing that the motion vector for the macro block of the layer 0 is identical to the motion vector obtained by scaling the motion vector of the corresponding block of the layer 1 is set to a value such as ‘1’.

III) If a cost for a difference between two vectors (mv and mvScaledBL) is smaller Man those of remaining cases, since the layer 0 resolution is twice the layer 1 resolution, when a difference between the two vectors (mv2 and mvScaledBL2) is less than ±1 pixels in x (horizontal) and y (vertical) directions, respectively, vector refinement information having one of +1, 0, and −1 for each of x and y components is recorded, and a refinement flag (refinement_flag) of ‘1’ is set in the header of the corresponding macro block.

Such an inter-layer prediction scheme has been applied only between layers having a difference resolution of a multiple of ×2, such as QCIF and CIF, or CIF and 4CIF as shown in FIG. 1. In other words, a video signal of a layer having resolution of the CIF is predicted based on a layer having resolution of QCIF, and a video signal of a layer having resolution of 4CIF is predicted based on a layer having resolution of the CIF.

However, similarly to the prediction for the video signal of the layer having resolution of 4CIF based on the layer having resolution of the QCIF, it is necessary to improve a coding efficiency by performing the inter-layer prediction operation between layers having a resolution difference of ×4.

### SUMMARY OF THE INVENTION

Accordingly, the present invention has been made to solve the above-mentioned problems occurring in the prior art, and an object of the present invention is to provide a method for encoding a video signal by employing an inter-layer prediction scheme between layers having a resolution difference of ×4 and decoding the encoded signal, thereby improving a coding efficiency.

In order to accomplish the object of the present invention, there is provided a method for encoding a video signal, the method comprising the steps of: generating a bit stream of a second layer by encoding the video signal through a predetermined scheme; and generating a bit stream of a first layer by scalably encoding the video signal based on the bit stream of the second layer, wherein the bit stream of the second layer has a frame image size corresponding to a quarter a frame image size of the bit stream of the first layer.

According to the embodiment of the present invention, indication information is recorded on a header field of the video block, the indication information indicating that the video block of the first layer is divided based on division information about the corresponding block of the second layer and encoded based on mode information and/or motion information about the corresponding block.

According to the embodiment of the present invention, a motion vector of the video block of the first layer is encoded into a difference value between a resultant value obtained by enlarging a motion vector of a block of the second layer corresponding to the video block of the first layer by four times and a value of the motion vector of the video block of the first layer, and the motion vector of the video block of the first layer are encoded by distinguishing a case in which the difference value is less than ±3 pixels in x-axis and y-axis directions, respectively, from a case in which the difference value exceeds ±3 pixels.

According to another aspect of the present invention, there is provided a method for decoding an encoded video bit stream, the method comprising the steps of: decoding a bit stream of a second layer encoded through a predetermined scheme; and decoding a bit stream of a first layer scalably encoded using decoding information from the bit stream of the second layer, wherein the bit stream of the second layer has a frame image size corresponding to a quarter a frame image size of the bit stream of the first layer.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating a ‘2D+t’ structure of a scalable codec;

FIG. 2 is a view illustrating a typical scheme for generating a prediction image and dividing a macro block of an enhanced layer having twice resolution of a base layer using division information and/or motion information of the base layer;

FIG. 3 is a block diagram illustrating the structure of a video signal encoding device employing a scalable coding scheme for a video signal according to the present invention;

FIG. 4 is a view illustrating a temporal decomposition procedure for a video signal in a temporal decomposition level;

FIG. 5 is a view illustrating a typical scheme for generating a prediction image and dividing a macro block of an enhanced layer having four times resolution of a base layer using division information and/or motion information of the base layer;

FIG. 6 is a block diagram illustrating the structure of a device of decoding data stream encoded by the device shown in FIG. 3; and

FIG. 7 is a view illustrating the structure performing temporal composition with respect to the sequence of H frames and the sequence of L frames in a certain temporal decomposition level so as to make the sequence of L frames in a next temporal decomposition level.

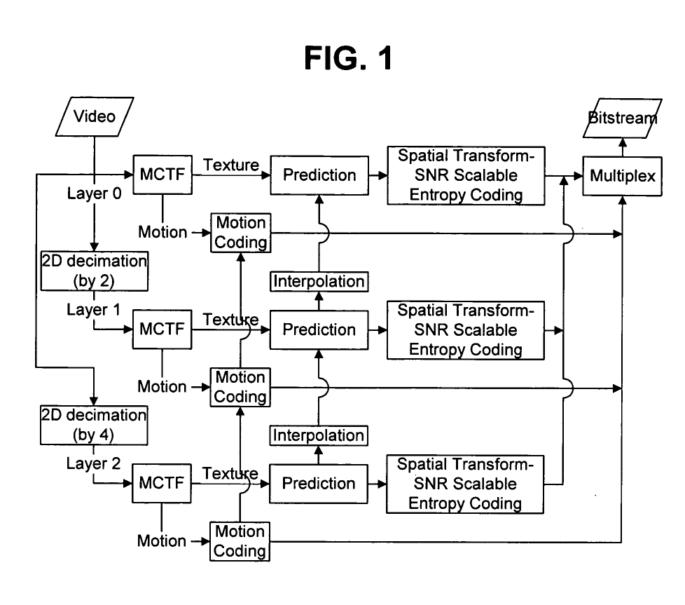

### DETAILED DESCRIPTION OF THE PREFERRED EMBODIMENTS

Hereinafter, preferred embodiments of the present invention will be described with reference to the accompanying drawings. In the following description and drawings, the same reference numerals are used to designate the same or similar components, and so repetition of the description on the same or similar components will be omitted.

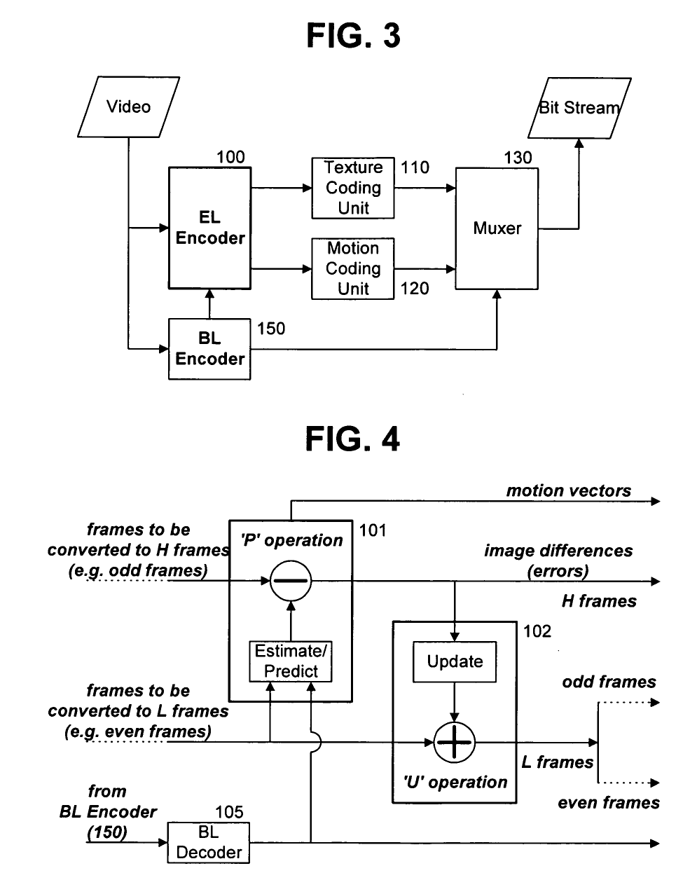

FIG. 3 is a block diagram illustrating the structure of a video signal encoding device employing a scalable coding scheme for a video signal according to the present invention.

The video signal encoding device shown in FIG. 3 includes an enhanced layer (EL) encoder 100 for scalably encoding an input video signal based on a macro block through a Motion Compensated Temporal Filter (MCTF) scheme and generating suitable management information, a texture coding unit 110 for converting the encoded data of each macro block into a compressed bit string, a motion coding unit 120 for coding motion vectors of a video block obtained from the EL encoder 100 into a compressed bit string through a specific scheme, a base layer encoder 150 for encoding an input video signal through a predetermined scheme such as the MPEG 1, 2, 4, H.261, or H.264 and generating the sequence of small-sized videos such as picture sequences having a half or a quarter original resolution if necessity, a muxer 130 for encapsulating the output data of the texture coding unit 110, the picture sequence of the BL encoder 150, and an output vector data of the motion coding unit 120 in a predetermined format, multiplexing the data with each other in a predetermined format, and then outputting the multiplexed data.

The EL encoder 100 performs a prediction operation for subtracting a reference block obtained through motion estimation from a macro block in a predetermined video frame (or picture) and performs an update operation by adding the image difference between the macro block and the reference block to the reference block. In addition, the EL encoder 100 may additionally perform a residual prediction operation with respect to the macro block representing the image difference with regard to the reference block by using base layer data

The EL encoder 100 divides the sequence of input video frames into frames, which will have image difference values, and frames, to which the image difference values will be added. For example, the EL encoder 100 divides the input video frames into odd frames and even frames. Then, the EL encoder 100 performs the prediction operation and the update operation with respect to, for example, one group of pictures (GOP) through several levels until the number of L frames (frames generated through the update operation) becomes one. FIG. 4 illustrates the structure relating to the prediction operation and the update operation in one of the above levels.

The structure shown in FIG. 4 includes a BL decoder 105, for extracting encoded information including division information, mode information, and motion information from a base layer stream for the small-sized image sequence encoded in the BL encoder 150 and decoding the encoded base layer stream, an estimation/prediction unit 101 for estimating a reference block for each macro block included in a frame, which may have residual data through motion estimation, that is an odd frame, in even frames provided before or after the odd frame (inter-frame mode), in its own frame (intra mode), or in a contemporary frame of the base layer (inter-layer prediction mode) and performing a prediction motion for calculating a motion vector and/or a image difference between the macro block and the reference block (difference values between corresponding pixels), and an update unit 102 for performing the update operation through which an image difference calculated with respect to the macro block is normalized and the normalized image difference is added to a corresponding reference block in the adjacent frame (e.g., the even frame) including the reference block for the macro block.

The operation performed by the estimation/prediction unit 101 is called a “P” operation, a frame generated through the P operation is called an “H” frame, and residual data existing in the H frame reflects a harmonic component of a video signal. In addition, the operation performed by the update unit 102 is called a “U” operation, a frame generated through the U operation is called an “L” frame, and the L frame has a low sub-band picture.

The estimation/prediction unit 101 and the update unit 102 shown in FIG. 4 can parallely and simultaneously process a plurality of slices divided from one frame instead of a frame unit. In the following description, the term “frame” can be replaced with the “slices” if it does not make technical difference, that is, the frame includes the meaning of the slices.

The estimation/prediction unit 101 divides input video frames or odd frames of L frames obtained through all levels into macro blocks having a predetermined size, searches temporally adjacent even frames or a current frame in the same temporal decomposition level for blocks having the most similar images to images of divided macro blocks, makes a prediction video of each macro block based on the searched block, and finds a motion vector of the macro block. The estimation/prediction unit 101 may encode input video frames or odd frames of L frames obtained through all levels using the frame of the base layer temporally simultaneous with the current frame.

A block having the highest correlation has the smallest image difference between the block and a target block. The image difference is determined as the sum of pixel-to-pixel difference values or the average of the sum. The smallest macro block (the smallest macro blocks among blocks) having at most a predetermined threshold value is (are) called a reference block (reference blocks).

If the reference block is searched in the adjacent frame or the current frame, the estimation/prediction unit 101 finds a motion vector to the reference block from the current macro block to be delivered to the motion coding unit 120 and calculates a pixel difference value between each pixel value of the reference block (in a case of one frame) or each mean pixel value of reference blocks (in a case of plural frames) and each pixel value of the current macro block, or a pixel difference value between each pixel average value of the reference block (in a case of plural frames) and the pixel value of the current macro block, thereby encoding a corresponding macro block. In addition, the estimation/prediction unit 101 inserts a relative distance between a frame including the selected reference block and a frame including the current macro block and/or one of reference block modes such as a Skip mode, a DirInv mode, a Bid mode, a Fwd mode, a Bwd mode, and an intra mode into a header field of the corresponding macro block.

The estimation/prediction unit 101 performs the procedure with respect to all macro blocks in a frame, thereby making an H frame for the frame. In addition, the estimation/prediction unit 101 makes H frames, which are prediction videos for frames, with respect to input video frames or all odd frames of L frames obtained through all levels.

As described above, the update unit 102 adds image difference values for macro blocks in the H fame generated by the estimation/prediction unit 101 to L frames (input video frames or even frames of L frames obtained through all levels) having corresponding reference blocks.

Hereinafter, according to an embodiment of the present invention, an inter-layer prediction scheme between a base layer and an enhanced layer having four times resolution difference will be described. That is, a scheme for creating a prediction video for an enhanced layer having resolution of 4CIF using a base layer having resolution of QCIF will be described.

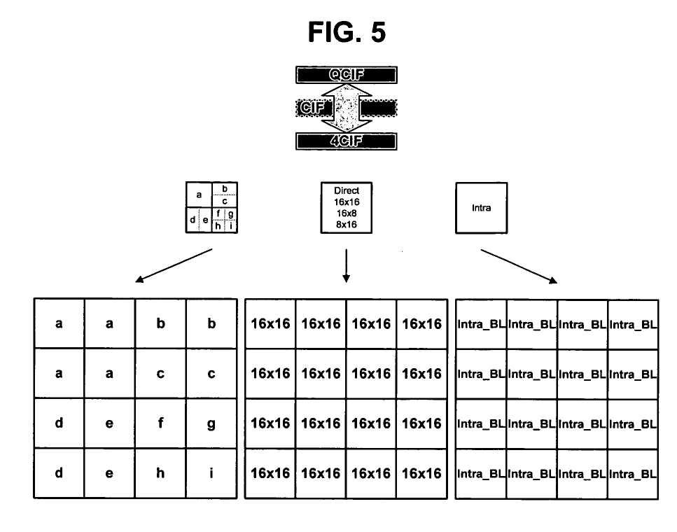

A scheme for creating a prediction video by dividing a macro block of the enhanced layer having resolution of 4CIF using motion information and/or division information about a macro block in a frame of the base layer having resolution of QCIF will be described with reference to FIG. 5.

The estimation/prediction unit 101 divides a current macro block of an enhanced layer based on division information about a corresponding block of a base layer corresponding to the current macro block (herein, among blocks of the base layer positioned at a frame temporally simultaneous with the current macro block of the enhanced layer, the corresponding block denotes a block having an area covering the current macro block when the size of the corresponding block is enlarged according to the ratio (four times) of an image size of the base layer to an image size of the enhanced layer) and the ratio of resolution of the enhanced layer to resolution of the base layer. Then, the estimation/prediction unit 101 encodes blocks of the enhanced layer divided through the division information about the corresponding block of the base layer based on motion information about divided blocks of the base layer, for example, a motion vector and a reference index indicating a frame including a reference block. Herein, since the ratio of an image size of the base layer to an image size of the enhanced layer is four, 16 macro blocks of the enhanced layer having a size of 16×16 may be encoded based on division information and motion information about the corresponding block of the base layer having a size of 16×16.

A 4×4-sized block of the base layer corresponds to one 16×16-sized macro block of the enhanced layer. However, since a 4×8-sized block or a 8×4-sized block of the base layer is enlarged to a 16×32-sized macro block or a 32×6-sized macro block, which correspond to four times the 4×8-sized block or four times the 8×4-sized block, respectively, larger than the maximum size of 16×16 of a macro block, the 4×8-sized block or the 8×4-sized block of the base layer cannot correspond to one macro block. Accordingly, the 4×8-sized block or the 8×4-sized block of the base layer corresponds to two 16×16-sized macro blocks of the enhanced layer by including a neighboring macro block. In the same manner, a 8×8-sized macro block of the base layer corresponds to four 16×16-sized macro blocks of the enhanced layer, an 8×16-sized macro block or a 16×8-sized block of the base layer corresponds to eight 16×16-sized macro blocks of the enhanced layer, and a 16×16-sized block of the base layer corresponds to 16 16×16-sized macro blocks.

In this case, the estimation/prediction 101 encodes a plurality of macro blocks of the enhanced layer corresponding to the same block of the base layer using motion information, that is, a reference index and a motion vector, about the block of the base layer.

For example, if the block of the base layer commonly corresponding to a plurality of macro blocks of the enhanced layer is encoded in a direct mode, the macro blocks of the enhanced layer are encoded into 16×16 blocks. In addition, if a block of a base layer commonly corresponding to a plurality of macro blocks of the enhanced layer is encoded in an intra mode, the macro blocks of the enhanced layer are encoded in an intra base mode (intra_BASE mode) by employing the commonly corresponding block of the base layer as a reference block.

In addition, the estimation/prediction unit 101 sets a base layer mode flag (base_layer_mode_flag), which indicates that a macro block of the enhanced layer is divided and encoded according to division information and motion information about a block of the base layer, to a value such as ‘1’ and records the flag on a header field of the macro block.

Hereinafter, a scheme for encoding a motion vector of an enhanced layer having resolution of 4CIF temporally simultaneous with a base layer having resolution of QCIF by using a motion vector of the base layer will be described.

The estimation/prediction unit 101 finds a motion vector (mv2) as a reference block through a motion prediction operation for a predetermined macro block in a frame of the enhanced layer and finds a motion vector (mvScaledBL2) by scaling a motion vector (mvBL2) of a macro block covering an area in a frame of the base layer corresponding to the macro block by four times the ratio of the enhanced resolution to the base layer resolution. Thereafter, with respect to each of the two vectors (mv2 and mvScaledBL2) and a difference between the two vectors (mv2 and mvScaledBL2), the encoding scheme is sub-divided into three schemes according to costs calculated based on a residual error which is a difference between prediction images generated by the two vectors (mv2 and mvScaledBL2) and a real image and the number of total bits to be used in encoding are as follows.

That is, I) if the cost of the motion vector (mv2) is smaller than costs corresponding to remaining two schemes, encoding is performed in such a manner that the motion vector found in the enhanced layer can be used.

II) If the motion vector (mvScaledBL2) has a smaller cost as compared with those of remaining schemes, the estimation/prediction 101 records information, which indicates that the motion vector for the macro block of the enhanced layer is identical to the motion vector obtained by scaling the motion vector of the corresponding block of the base layer, on the header of the corresponding macro block. In other words, the estimation/prediction unit 101 does not provide additional motion vector information, but sets a flag (base_layer_mode_flag) representing that the motion vector for the macro block of the enhanced layer is identical to the motion vector obtained by scaling the motion vector of the corresponding block of the base layer to a value such as ‘1’.

III) If a cost for a difference between two vectors (mv2 and mvScaledBL2) is smaller than those of remaining cases, since the enhanced layer resolution is four times the base layer resolution, when a difference between the two vectors (mv2 and mvScaledBL2) is less than ±3 pixels in x (horizontal) and y (vertical) directions, respectively, vector refinement information having one of [−3, 3], that is, −3, −2, −1, 0, +1, +2, and +3, for each of x and y components is recorded, and a refinement flag (refinement_flag) of ‘1’ is set in the header of the corresponding macro block. Herein, since each of x and y components has one of seven values of [−3, 3], each of x and y components may be represented as 3 bits. In addition, the refinement flag may be represented as 1 bit Accordingly, a motion vector may be represented as 7 bits smaller than 1 byte.

In a texture prediction mode, the estimation/prediction unit 101 determines whether or not a corresponding area (which has the pixels corresponding to a quarter of pixels of the macro block in the x and y-axis directions, respectively) of the base layer, which is temporally simultaneous with a macro block of the enhanced layer for a current prediction image and has a relative position identical to that of the macro block in a frame, has been encoded in an intra mode based on mode information of each macro block in the base layer extracted from the BL decoder 105. If the corresponding area has been encoded in an intra mode, the estimation/prediction unit 101 reconstructs an original block image based on pixel values of another area for the intra mode, enlarges the reconstructed area to the size of the macro block of the enhanced layer by up-smapling the reconstructed area to four times the size of the area corresponding to the ratio of the resolution of the enhanced layer to the resolution of the base layer, and then encodes difference values between pixel values of the enlarged area and the macro block into the prediction image for the macro block of the enhanced layer. Thereafter, the estimation/prediction unit 101 sets the intra_bas_flag, which indicates that the macro block is encoded based on the corresponding area encoded in the intra mode of the base layer, to a value such as ‘1’ and records the flag on the header field of the macro block.

In a residual prediction mode, the estimation/prediction unit 101 finds a residual block of the enhanced layer (the residual block is encoded to have residual data) through a prediction operation for a macro block in a predetermined frame of a main picture sequence. Then, the estimation/prediction unit 101 extracts a corresponding residual area, which is temporally simultaneous to the macro block and has a relative position identical to that of the macro block in a frame, from a bit stream of the base layer encoded by the BL encoder 150, enlarges the corresponding residual area to the size of the macro block by ×4 up-smapling the residual area corresponding to the resolution difference between the enhanced layer and the resolution of the base layer, subtracts pixel values of the enlarged residual area of the base layer from pixel values of the residual block of the enhanced layer, and then encodes the resultant value in the macro block. Thereafter, the estimation/prediction unit 101 sets the residual_prediction_flag, which indicates that the macro block is encoded to have the difference value of the residual data, to a value such as ‘1’ and records the flag on the header field of the macro block.

A data stream encoded through the above-described scheme may be delivered to a decoding device through wire or wireless transmission or by means of storage medium. The decoding device reconstructs an original video signal according to a scheme to be described below.

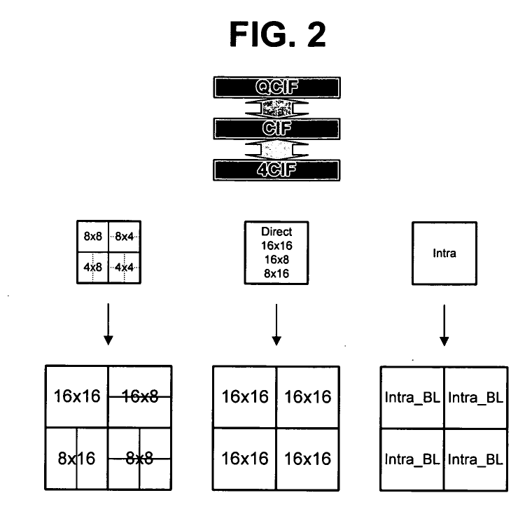

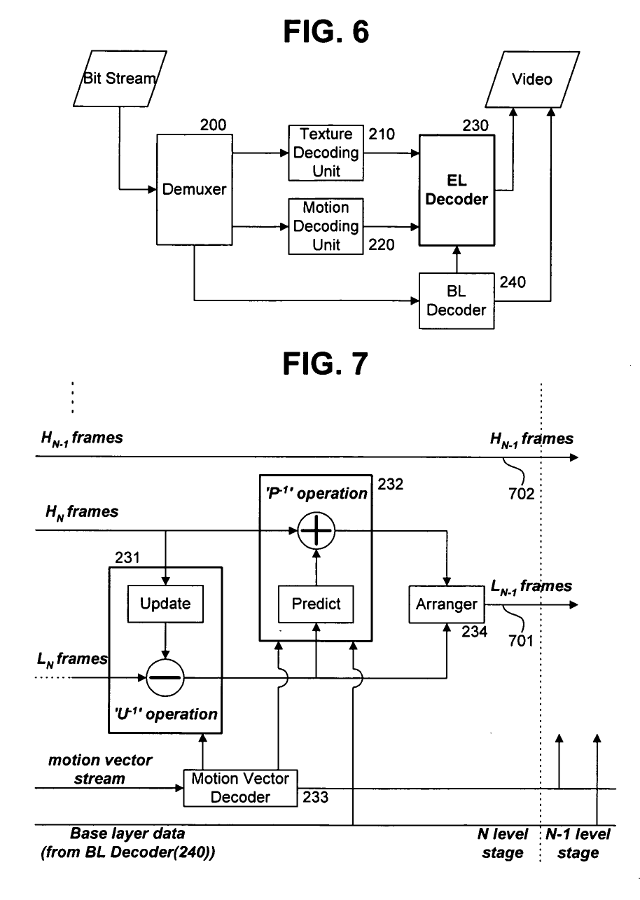

FIG. 6 is a block diagram illustrating the structure of the decoding device for decoding the data stream encoded by the device shown in FIG. 2. The decoder shown in FIG. 6 includes a de-muxer 200 for dividing the received data stream into a compressed motion vector stream and a compressed macro block information stream, a texture decoding unit 210 for recovering an original uncompressed information stream from the compressed macro block information stream, a motion decoding unit 220 for recovering an original uncompressed stream from a compressed motion vector stream, an enhanced layer (EL) decoder 230 for converting the uncompressed macro block information stream and the motion vector stream into an original video signal through an MCTF scheme, and a base layer (BL) decoder 240 for decoding base layer stream through a predetermined scheme such as the MPEG 4 scheme or the H.264 scheme. The EL decoder 230 uses base layer encoding information such as division information, mode information, and motion information of each macro block and reconstructed data of the base layer directly extracted from the base layer stream, or obtained by inquiring the information and the data from the BL decoder 240.

The EL decoder 230 decodes an input stream into data having an original frame sequence, and FIG. 7 is a block diagram illustrating the main structure of the EL decoder 230 employing the MCTF scheme in detail.

FIG. 7 illustrates the structure performing temporal composition with respect to the sequence of H frames and the sequence of L frames so as to make the sequence of L frames in a temporal decomposition level of N−1. The structure shown in FIG. 7 includes an inverse update unit 231 for selectively subtracting difference pixel values of input H frames from pixel values of input L frames, an inverse prediction unit 232 for recovering L frames having original images using the H frames and L frames obtained by subtracting the image difference values of the H frames from the input L frames, a motion vector decoder 233 for providing motion vector information of each block in the H frames to both the inverse update unit 231 and the inverse prediction unit 232 in each stage, and an arranger 234 for making a normal L frame sequence by inserting the L frames formed by the inverse prediction unit 232 into the L frames output from the inverse update unit 231.

The L frame sequence output by the arranger 234 becomes the sequence of L frames 701 in a level of N−1 and is restored to the sequence of L frames by an inverse update unit and an inverse prediction unit in a next stage together with the sequence of input H frames 702 in the level of N−1. This procedure is performed by the number of levels in the encoding procedure, so that the sequence of original video frames is obtained.

Hereinafter, a recovering procedure (a temporal composition procedure) in the level of N of recovering an L frame in the level of N−1 from the received H frame in the level of N and the L frame in the level of N having been generated from the level of N+1 will be described in more detail.

In the meantime, with respect to a predetermined L frame (in the level of N), in consideration of a motion vector provided from the motion vector decoder 233, the inverse update unit 231 detects an H frame (in the level of N) having image difference found using a block in an original L frame (in the level of N−1) updated to a predetermined L frame (in the level of N) through the encoding procedure as a reference block and then subtracts image difference values for the macro block in the H frame from pixel values of the corresponding block in the L frame.

The inverse update operation is performed with respect to a block updated using image difference values of a macro block in the H frame through the encoding procedure from among blocks in the current L frame (in the level of N), so that the L frame in the level of L−1 is reconstructed.

In a macro block in a predetermined H frame, the inverse prediction unit 232 detects a reference block in an L frame (the L frame is inverse-updated and output by the inverse update unit 231) based on the motion vector provided from the motion vector decoder 233 and then adds pixel values of the reference block to difference values of pixels of the macro block, thereby reconstructing original video data.

In addition, if the macro block of the H frame has been encoded through the inter-layer prediction scheme using the base layer, the inverse prediction unit 232 reconstructs an original image for the macro block through a decoding scheme corresponding to the texture prediction scheme, the residual prediction scheme, or the motion prediction scheme. Description about these schemes will be given below.

If original video data are recovered from all macro blocks in the current H frame through the above described operation, and the macro blocks undergo a composition procedure so that an L frame is recovered, the L frame is alternatively arranged together with an L frame, which is recovered in the inverse update unit 231, through the arranger 234, so that the arranged frame is output to the next stage.

Hereinafter, a decoding scheme in a case in which a macro block in a predetermined H frame has been encoded through the inter-layer prediction scheme by using the base layer will be described.

The inverse prediction unit 232 determines the ratio of the resolution of the enhanced layer to the resolution of the base layer based on a flag of “base_layer_id_plus1” provided by the BL decoder 240 or extracted from the data stream of the base layer. If a difference between “current_layer_id” and “base_layer_id_plus1” is ‘2’, the enhanced layer and the base layer represent a resolution difference of ×4. Hereinafter, a case in which a difference between the resolution of the enhanced layer and the base layer has a multiple of four will be described.

If the base_layer_mode_flag is set to a value such as ‘1’ in the header of the macro block of the predetermined H frame, the inverse prediction unit 232 reconstructs an original image for the macro block based on motion information of the corresponding block of the base layer which is temporally simultaneous with the macro block and has a position identical to that of the macro block in a flame.

Since the motion information about the corresponding block includes a reference index, which indicates a frame including a reference block, and a motion vector if the corresponding block has been encoded in the inter-frame mode, the inverse prediction unit 232 detects the reference block in the L frame of the enhanced layer based on a result obtained by enlarging the reference index and the motion vector to four times their sizes in an x-axis direction and a y-axis direction and reconstructs an original image by adding pixel values of the reference block to difference values of pixels of the macro block. If the corresponding block has been encoded in the direct mode, the inverse prediction unit 232 reconstructs an original image by detecting the reference block based on a motion vector found using either a motion vector of a previous macro block in a previous H frame of the enhanced layer having a position identical to that of the macro block or a motion vector for another macro block around the macro block. In addition, if the corresponding block has been encoded in the direct mode, the inverse prediction unit 232 may find a motion vector using either the motion vector of the previous macro block in the previous H frame having a position identical to that of the macro block or a motion vector of another macro block around the corresponding macro block, enlarge the found motion vector to four times the size of the motion vector in an x-axis direction and in an y-axis direction, and then use the enlarged result in order to reconstruct the original image data.

In addition, if the corresponding block has been encoded in the intra mode, the inverse prediction unit 232 reconstructs a corresponding area (having the number of pixels corresponding to a quarter that of the macro block in an x-axis direction and in an y-axis direction) in the corresponding block, which has a relative position identical to that of the macro block in a frame, based on pixel values of another area for the intra mode, enlarges the reconstructed corresponding area to the size of the macro block by up-sampling the size of the reconstructed corresponding area by four times the size thereof, and reconstructs an original image of the macro block by adding pixel values of the enlarged corresponding area to pixel difference values of the macro block.

If the refinement_flag has been set to a value such as ‘1’ in the header of the macro block in the predetermined H frame, the inverse prediction unit 232 enlarges a motion vector of a corresponding block of the base layer, which is temporally simultaneous with the macro block and has a position identical to that of the macro block in a frame, to four times the size of the motion vector in an x-axis direction and in an y-axis direction and adds vector refinement information within the range of [−3, 3] to x and y components of the motion vector, thereby finding a motion vector for the macro block. Then, the inverse prediction unit 232 detects a reference block of an L frame of the enhanced layer based on the found motion vector and adds pixel values of the reference block to pixel difference values of the macro block, thereby reconstructing an original image.

If the motion_prediction_flag has been set to a value such as ‘1’ in the header of the macro block in the predetermined H frame, the inverse prediction unit 232 enlarges a motion vector of a corresponding block of the base layer, which is temporally simultaneous with the macro block and has a position identical to that of the macro block in a frame, by four times the size of the motion vector in an x-axis direction and an y-axis direction and adds a difference value of a motion vector encoded for the macro block thereto, thereby finding a motion vector for the macro block. Then, the inverse prediction unit 232 detects a reference block of an L frame of the enhanced layer based on the found motion vector and adds pixel values of the reference block to pixel difference values of the macro block, thereby reconstructing an original image.

If the intra_BASE_flag has been set to a value such as ‘1’ in the header of the macro block, the inverse prediction unit 232 reconstructs a corresponding area in the base layer encoded in the intra mode (the corresponding area has the number of pixels corresponding to a quarter that of the macro block in an x-axis direction and in an y-axis direction), which has a relative position identical to that of the macro block in a frame, based on pixel values of another area for the intra mode, enlarges the reconstructed corresponding area to the size of the macro block by up-sampling the size of the reconstructed corresponding area by four times the size thereof, and adds pixel values of the enlarged corresponding area to pixel difference values of the macro block, thereby reconstructing an original image of the macro block.

If the residual_prediction_flag has been set to a value such as ‘1’ in the header of the macro block in the predetermined H frame, the inverse prediction unit 232 determines that the macro block has been encoded into difference values of residual data, enlarges a corresponding area in the base layer (the corresponding area has the number of pixels corresponding to a quarter that of the macro block in an x-axis direction and in an y-axis direction), which has a relative position identical to that of the macro block in a frame, to the size of the macro block by up-sampling the size of the corresponding area by four times the size thereof, and adds pixel values of the enlarged corresponding area to pixel difference values of the macro block encoded into the difference values of residual data, thereby finding a residual block of the macro block (the residual block has image difference values, that is, residual data). Thereafter, the inverse prediction unit 232 detects a reference block in the L frame based on a motion vector provided by the motion vector decoder 233 and then adds pixel values of the reference block to pixel values of the macro block having the image difference values, thereby reconstructing an original image of the macro block.

As described above, a perfect video frame sequence is recovered from the encoded data stream. In particular, when one GOP undergoes N prediction operations and N update operations through the encoding procedure in which the MCTF scheme may be employed, if N inverse update operations and N inverse prediction operations are performed in an MCTF decoding procedure, video quality of an original video signal can be obtained. If the operations are performed by the frequency number smaller than N, a video frame may have relatively smaller bit rates even though the video quality of the video frame is degraded somewhat as compared with a video frame through N operations. Accordingly, the decoder is designed to perform the inverse update operation and the inverse prediction operation suitably for the performance of the decoder.

The above-described decoder may be installed in a mobile communication terminal or a device for reproducing record media.

According to the present invention, as described above, when a video signal is scalably encoded, an inter-layer prediction scheme is applied between layers representing a resolution difference of ×4, thereby improving a coding efficiency.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A method for encoding a video signal, the method comprising the steps of:
generating a bit stream of a second layer by encoding the video signal through a predetermined scheme; and
generating a bit stream of a first layer by scalably encoding the video signal based on the bit stream of the second layer,
wherein the bit stream of the second layer has a frame image size corresponding to a quarter a frame image size of the bit stream of the first layer.

2. The method as claimed in claim 1, wherein a video block of the first layer is divided based on division information about a corresponding block of the second layer corresponding to the video block and encoded based on mode information and/or motion information about the corresponding block of the second layer.

3. The method as claimed in claim 2, wherein the step of generating the bit seam of the first layer further includes a step of recording indication information on a header field of the video block, the indication information indicating that the video block of the first layer is divided based on division information about the corresponding block of the second layer and encoded based on mode information and/or motion information about the corresponding block.

4. The method as claimed in claim 1, wherein a motion vector of the video block of the first layer is encoded into a difference value between a resultant value obtained by enlarging a motion vector of a block of the second layer corresponding to the video block of the first layer by four times and a value of the motion vector of the video block of the first layer, and the motion vector of the video block of the first layer are encoded by distinguishing a case in which the difference value is less than ±3 pixels in x-axis and y-axis directions, respectively, from a case in which the difference value exceeds ±3 pixels.

5. The method as claimed in claim 4, wherein if the difference value is less than 3 pixels in the x-axis and y-axis directions, respectively, the motion vector of the video block of the first layer is encoded while representing the x component and the y component of the difference value in 3 bits,
wherein the step of generating the bit stream of the first layer further includes a step of recording indication information on the header field of the video block, the indication information indicating that the motion vector of the video block of the first layer is encoded by representing the x component and the y component of the difference value in 3 bits.

6. A method for decoding an encoded video bit stream, the method comprising the steps of:
decoding a bit stream of a second layer encoded through a predetermined scheme; and
decoding a bit stream of a first layer scalably encoded using decoding information from the bit stream of the second layer,
wherein the bit stream of the second layer has a frame image size corresponding to a quarter a frame image size of the bit stream of the first layer.

7. The method as claimed in claim 6, wherein the frame image sizes of the bit streams of both the first layer and the second layer are determined based on information included in the bit streams, respectively.

8. The method as claimed in claim 6, wherein the step of decoding the bit stream of the first layer includes a step of reconstructing an original image for the video block based on mode information and/or motion information of a block of the second layer corresponding to the video block of the first layer.

9. The method as claimed in claim 6, wherein the step of decoding the bit stream of the first layer includes a step of finding a motion vector for the video block by adding a predetermined value to a motion vector of the block of the second layer corresponding to the video block of the first layer, the predetermined value being a difference value between the motion vector of the video block of the first layer and a resultant vector obtained by enlarging the motion vector of the corresponding block to four times the motion vector of the corresponding block, the difference value being represented in 3 bits in an x component and in an y component.
